(19) United States
(12) Patent Application Publication
(10) Pub. No.: US 2015/0022927 A1
(43) Pub. Date: Jan. 22, 2015

(54) PROTECTION CIRCUIT FOR FAN

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: BO TIAN, Shenzhen (CN); KANG WU, Shenzhen (CN)

(21) Appl. No.: 14/336,045

(22) Filed: Jul. 21, 2014

(30) Foreign Application Priority Data
Jul. 19, 2013 (CN) 2013103025909

(51) Int. Cl. H02H 7/00; H02H 3/08

(52) U.S. Cl. CPC H02H 7/00; H02H 3/08
USPC 361/93.7

(57) ABSTRACT

A fan with a protection circuit includes a connector, a fan operation circuit, and a protection circuit. The protection circuit includes a first resistor, a controller, and an electronic switch. The controller controls the electronic switch to be turned off when a current flowing through the first resistor is greater than a preset current. The controller controls the electronic switch to be turned on when the current flowing through the first resistor is less than the preset current, then the fan resumes normal working.

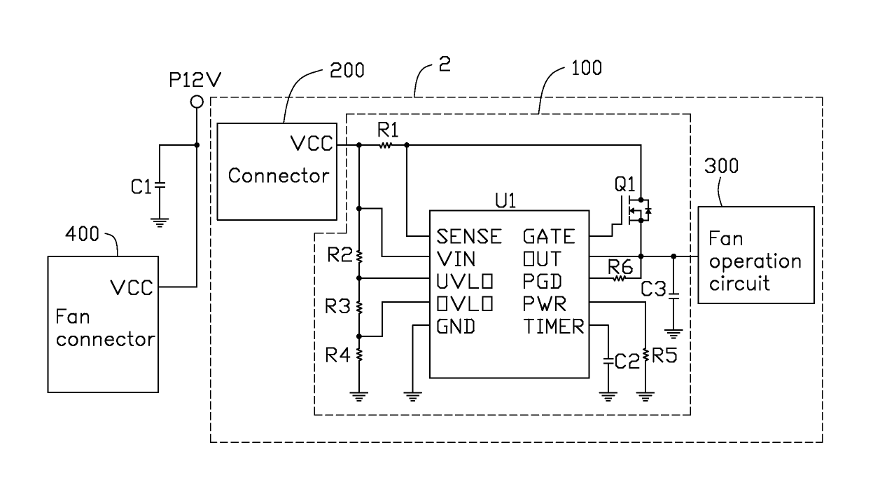

### FIELD

The subject matter herein generally relates to cooling fans of electronic devices.

### BACKGROUND

Fans are arranged in electronic devices to dissipate heat. Protection circuits for fans are arranged on motherboards of electronic devices.

### BRIEF DESCRIPTION OF THE DRAWINGS

Implementations of the present technology will now be described, by way of example only, with reference to the attached FIGURE.

The FIGURE is a circuit diagram of an embodiment of a fan with a protection circuit.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

The present disclosure is described in relation to a fan 2.

The FIGURE illustrates a fan 2 which can comprise a connector 200, a fan operation circuit 300, and a protection circuit 100. The protection circuit 100 can comprise a controller U1, an electronic switch Q1, resistors R1-R6, and capacitors C2, C3.

A sense pin SENSE of the controller U1 is coupled to a power pin VCC of the connector 200 through the resistor R1. An input pin VIN of the controller U1 is coupled to the power pin VCC of the connector 200. A first voltage pin UVLO of the controller U1 is coupled to the input pin VIN of the controller U1 through the resistor R2. A second voltage pin OVLO of the controller U1 is coupled to the first voltage pin UVLO of the controller U1 through the resistor R3. The second voltage pin OVLO of the controller U1 is also coupled to ground through the resistor R4. A ground pin GND of the controller U1 is coupled to ground. A timing pin TIMER of the controller U1 is coupled to ground through the capacitor C2. A control pin PWM of the controller U1 is coupled to ground through the resistor R5. A power good pin PGD of the controller U1 is coupled to an output pin OUT of the controller U1 through the resistor R6. The output pin OUT of the controller U1 is coupled to the fan operation circuit 300, and is coupled to ground through the capacitor C3. A gate pin GATE of the controller U1 is coupled to a control terminal of the electronic switch Q1. A first terminal of the electronic switch Q1 is coupled to the sense pin SENSE of the controller U1. A second terminal of the electronic switch Q1 is coupled to the output pin OUT of the controller U1.

A fan connector 400 is located on a motherboard for connection to the connector 200 of the fan 2. A power pin VCC of the fan connector 400 is coupled to a power supply P12V of the motherboard.

In operation, the connector 200 of the fan 2 is connected to the fan connector 400 of the motherboard. The power supply P12V supplies power to the fan 2 through the fan connector 400.

When a current flowing through the resistor R1, as sensed by the sense pin SENSE and the input pin VIN of the controller U1, is greater than a preset current as determined by the controller U1, the gate pin GATE of the controller U1 outputs a first signal. The electronic switch Q1 receives the first signal and is turned off. The connector 200 is disconnected from the fan operation circuit 300. The fan operation circuit 300 does not receive power from the power supply P12V and the fan 2 is not activated.

When the current flowing through the resistor R1 is less than the preset current determined by the controller U1, the gate pin GATE of the controller U1 outputs a second signal. The electronic switch Q1 receives the second signal and is turned on. The connector 200 is connected to the fan operation circuit 300 through the electronic switch Q1. The fan operation circuit 300 receives power from the power supply P12V and the fan 2 works normally.

In at least one embodiment, the electronic switch Q1 can be an N-channel field effect transistor.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A fan comprising:
a connector;
a fan operation circuit configured to stop the fan when the fan operation circuit does not receive power and activate the fan when the fan operation circuit receives a power signal; and
a protection circuit coupled between the connector and the fan operation circuit, the protection circuit comprising a first resistor, a controller, and an electronic switch;
wherein the controller is configured to control the electronic switch to be turned off when a current flowing through the first resistor is greater than a preset current of the controller, thereby stopping the fan, and the controller is configured to control the electronic switch to be turned on when the current flowing through the first resistor is less than the preset current of the controller, thereby enabling the fan to operate

2. The fan of claim 1, wherein the protection circuit further comprises a second resistor, a third resistor, a fourth resistor, a fifth resistor, a sixth resistor, a first capacitor, and a second capacitor, a sense pin of the controller is coupled to a power pin of the connector through the first resistor, an input pin of the controller is coupled to the power pin of the connector, a first voltage pin of the controller is coupled to the input pin of the controller through the second resistor, a second voltage pin of the controller is coupled to the first voltage pin of the controller through the third resistor, the second voltage pin of the controller is also coupled to ground through the fourth resistor, a ground pin of the controller is coupled to ground, a timing pin of the controller is coupled to ground through the first capacitor, a control pin of the controller is coupled to ground through the fifth resistor, a power good pin of the controller is coupled to an output pin of the controller through the sixth resistor, the output pin of the controller is coupled to the fan operation circuit, and is coupled to ground through the second capacitor, a gate pin of the controller is coupled to a control terminal of the electronic switch, a first terminal of the electronic switch is coupled to the sense pin of the controller, a second terminal of the electronic switch is coupled to the output pin of the controller; wherein the gate pin outputs a first signal when the current flowing through the first resistor is greater than the preset current of the controller, and the gate pin outputs a second signal when the current flowing through the first resistor is less than the preset current of the controller.

3. The fan of claim 1, wherein the electronic switch is an N-channel field effect transistor.
